(19) United States
(12) Patent Application Publication
(10) Pub. No.: US 2026/0343390 A1
(43) Pub. Date: Oct. 29, 2026

(54) SLICE INFORMATION TRANSMISSION METHOD AND COMMUNICATION DEVICE

(71) Applicants: China Mobile Communication Co., Ltd Research Institute, BEIJING (CN); CHINA MOBILE COMMUNICATIONS GROUP CO., LTD., BEIJING (CN)

(72) Inventors: Miaoqi ZHANG, BEIJING (CN); Ningyu CHEN, BEIJING (CN); Liang LIU, BEIJING (CN)

(21) Appl. No.: 19/730,934

(22) Filed: Jul. 3, 2026

Related U.S. Application Data
(63) Continuation of application No. PCT/CN2025/071328, filed on Jan. 8, 2025.

(30) Foreign Application Priority Data
Jan. 8, 2024 (CN) 202410029665.9

(51) Int. Cl. H04W 48/16

(52) U.S. Cl. CPC H04W 48/16

(57) ABSTRACT

A slice information transmission method, performed by a core network function, includes: sending one or more pieces of first information to a base station. The one or more pieces of first information include second slice information. One or more second slices indicated by the second slice information are configured to replace a first slice.

### CROSS-REFERENCE TO RELATED APPLICATIONS

The present application is a continuation of International (PCT) Patent Application No. PCT/CN2025/071328 filed on Jan. 8, 2025, which claims foreign priority to Chinese Patent Application No. 202410029665.9, filed on Jan. 8, 2024, the contents of which are herein incorporated by reference in their entireties.

### TECHNICAL FIELD

The present disclosure relates to the field of communication technologies, and in particular to a slice information transmission method and a communication device.

### BACKGROUND

“Network slicing” is one of the landmark technologies that distinguish 5G from 4G. In contrast to the traditional 4G network that uses the “one pipeline and best-effort” mode, 5G network slicing aims to provide multiple end-to-end logical “dedicated networks” based on a unified infrastructure and a unified network architecture, thereby offering on-demand customized network services for different scenarios and optimally adapting to various service requirements of industry users.

In an Xn interface handover scenario, current solutions only support scenarios where congestion occurs at a target base station or the target base station does not support a slice currently serving a user equipment (UE). However, for scenarios where the slice becomes congested in a core network or the core network does not support the slice currently serving the UE, no effective solution is currently available.

In particular, a behavioral inconsistency may occur between a core (target) network and a target base station in terms of admission of a current slice during handover. In other words, the core (target) network does not support the slice currently serving the UE, while the target base station supports the slice currently serving the UE. Due to a lack of signaling interaction between the core (target) network and the target base station, and since the target base station is temporarily unable to report the admitted slices during reporting of a path switch request to the core (target) network after successfully performing slice admission control, a path switch failure may occur, service may be interrupted, and user experience may be affected.

### SUMMARY

Embodiments of the present disclosure provide a slice information transmission method and a communication device.

In a first aspect, some embodiments of the present disclosure provide a slice information transmission method, performed by a core network function. The method includes:
sending one or more pieces of first information to a base station, where the one or more pieces of first information include second slice information, and one or more second slices indicated by the second slice information are configured to replace a first slice.

In a second aspect, some embodiments of the present disclosure further provide a slice information transmission method, performed by a base station. The method includes:
receiving one or more pieces of first information sent by a core network function, where the one or more pieces of first information include second slice information, and one or more second slices indicated by the second slice information are configured to replace a first slice.

In a third aspect, some embodiments of the present disclosure further provide a communication device. The communication device includes a memory, a processor, and a computer program stored on the memory and executable on the processor. The processor is configured to execute the computer program to perform the slice information transmission method according to the above first aspect or the above second aspect of some embodiments of the present disclosure.

### BRIEF DESCRIPTION OF THE DRAWINGS

FIG. 1 is a first schematic flowchart of a slice information transmission method according to some embodiments of the present disclosure.

FIG. 2 is a second schematic flowchart of a slice information transmission method according to some embodiments of the present disclosure.

FIG. 3 is a third schematic flowchart of a slice information transmission method according to some embodiments of the present disclosure.

FIG. 4 is a fourth schematic flowchart of a slice information transmission method according to some embodiments of the present disclosure.

FIG. 5 is a fifth schematic flowchart of a slice information transmission method according to some embodiments of the present disclosure.

FIG. 6 is a first structural schematic diagram of a slice information transmission apparatus according to some embodiments of the present disclosure.

FIG. 7 is a second structural schematic diagram of a slice information transmission apparatus according to some embodiments of the present disclosure.

FIG. 8 is a structural schematic diagram of hardware components of a communication device according to some embodiments of the present disclosure.

### DETAILED DESCRIPTION

The present disclosure will be described in detail below in conjunction with the accompanying drawings and embodiments.

Technical solutions in some embodiments of the present disclosure may be applied to various communication systems, such as a global system of mobile communication (GSM) system, a long term evolution (LTE) system, or a 5G system, etc. In some embodiments, the 5G system or the 5G network may also be referred to as a new radio (NR) system or an NR network.

In some examples, a communication system applied in some embodiments of the present disclosure may include a network device and a user equipment (which may also be referred to as a terminal, a communication terminal, etc.). The network device may be a device configured to communicate with the user equipment. In some embodiments, the network device may provide communication coverage within a certain area and may communicate with a terminal located within the area. In some embodiments, the network device may be a base station in various communication systems, such as an evolved Node B (eNB) in the LTE system, or a base station in the 5G system or the NR system (e.g., an NG-RAN (Next Generation Radio Access Network) node, including a gNB and an ng-eNB).

It should be understood that, in some embodiments of the present disclosure, a device with a communication function in the network/system may be referred to as a communication device. The communication device may include a network device and a user equipment with the communication function. The network device and the user equipment may be the specific devices as described above and will not be described in detail herein. The communication device may further include other devices in the communication system, such as a network controller, a Mobility Management Entity (MME), and other network entities, which is not limited in some embodiments of the present disclosure.

It should be understood that the terms “system” and “network” may be often used interchangeably herein. The term “and/or” herein merely describes an association relationship describing associated objects and indicates that three types of relationships may exist. For example, “A and/or B” may indicate: A exists alone, A and B exist at the same time, or B exists alone. In addition, the character “/” herein generally indicates that the associated objects before and after are in an “or” relationship.

The terms “first”, “second”, and the like in the specification and claims of the present disclosure are used to distinguish similar objects and are not necessarily used to describe a specific order or sequence. It should be understood that the data used herein may be interchanged under appropriate circumstances, so that some embodiments of the present disclosure described herein can be implemented in an order other than that illustrated or described herein. In addition, the terms “including”, “having”, and any variations thereof are intended to cover non-exclusive inclusions. For example, a process, method, system, product, or device that includes a series of operations or units is not necessarily limited to those operations or units explicitly listed, but may also include other operations or units that are not explicitly listed or inherent to these processes, methods, products, or devices.

Before describing the technical solutions in some embodiments of the present disclosure in detail, a brief description is provided to a UE handover scenario in which a current core network slice becomes congested, the core network does not support a slice, or a slice is unavailable in the core network.

In a handover scenario, a source base station may send a handover preparation message to a target base station. The target base station may perform admission control and respond with or acknowledge a handover command. In a case where a current slice resource of the target base station becomes congested or the target base station does not support a slice currently serving a UE, a core network function (e.g., a Network Slice Selection Function (NSSF) or a Policy Control Function (PCF)) or an Operation Administration and Maintenance (OAM) will inform or notify an Access and Mobility Management Function (AMF) in a case where the core network function or the OAM detects that the current slice becomes unavailable or congested. An Allowed NSSAI (Network Slice Selection Assistance Information) indicates slices available to the UE under a serving Public Land Mobile Network (PLMN) within a registration area.

The UE may indicate support for network slice replacement feature during a registration phase. For a UE in a connected state, if a protocol data unit (PDU) session associated with a slice to be replaced already exists in a UE context, the AMF may select an alternative slice or replacement slice for the UE in the Allowed NSSAI or the Configured NSSAI within a UE configuration update message.

In a current Xn interface handover scenario, the source base station sends the handover request message to the target base station. If the target base station becomes congested or does not support a slice currently serving the UE at this time, the target base station acknowledges admitted PDU sessions and non-admitted PDU sessions in a handover request acknowledgement message to the source base station. After the handover is executed, the target base station needs to send, via a path switch request message, the admitted PDU sessions and the PDU sessions for which resource setup failed to the core network function. The core network function responds with a path switch request acknowledgement message. The path switch request acknowledgement message includes switched PDU sessions, released PDU sessions, and the Allowed NSSAI.

The above solution primarily addresses a scenario where the slice becomes congested at the target base station or a scenario where the target base station does not support the slice currently serving the UE. However, the above solution does not address a scenario where the slice becomes congested in the core network or a scenario where the core network does not support the slice currently serving the UE. In particular, a behavioral inconsistency may occur between a core (target) network and a target base station in terms of admission of a current slice during handover. For example, the core (target) network does not support the slice currently serving the UE, while the target base station supports the slice currently serving the UE. Due to a lack of signaling interaction between the core (target) network and the target base station, since the target base station is temporarily unable to report the admitted slices during reporting of a path switch request to the core (target) network after successfully performing slice admission control, and since the core (target) network has no resources to serve the slices, a path switch failure may occur, service may be interrupted, and user experience may be affected.

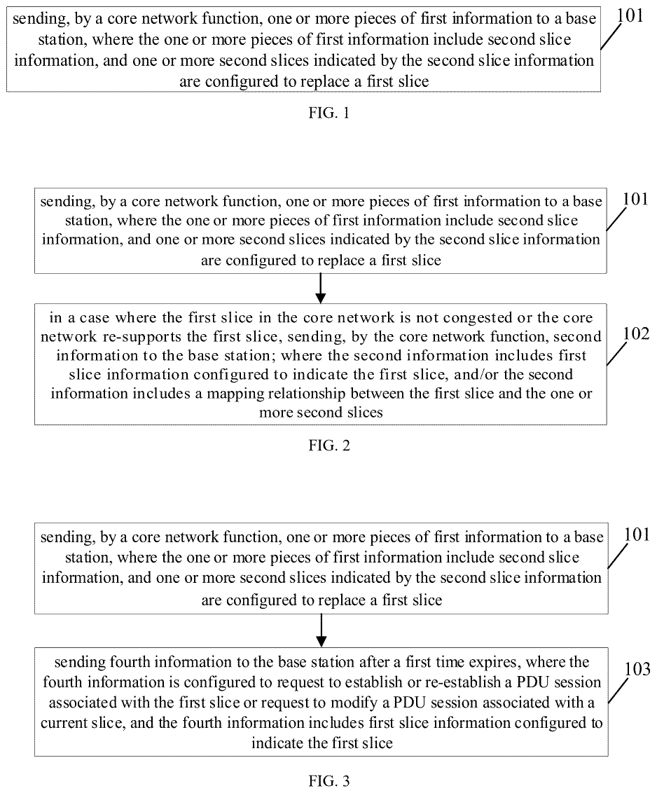

Based on this, some embodiments of the present disclosure provide a slice information transmission method. FIG. 1 is a first schematic flowchart of a slice information transmission method according to some embodiments of the present disclosure. As shown in FIG. 1, the method includes an operation 101.

At the operation 101, a core network function may send one or more pieces of first information to a base station. The one or more pieces of first information may include second slice information. One or more second slices indicated by the second slice information may be configured to replace a first slice.

The slice information transmission method of some embodiments of the present disclosure may be applied to or performed by a core network function. In some embodiments, the core network function may be a control plane network function of the core network, such as a Session Management Function (SMF) or an Access and Mobility Management Function (AMF) in a 5G core network. In other embodiments, the core network function may be other slice-related core network functions, or slice-related core network functions in other communication systems or even future communication systems.

In some embodiments, the first slice may be a slice currently serving the UE before or at the time of sending the one or more pieces of first information to the base station. The one or more second slices may be alternative slices indicated by the core network function to replace the first slice. In some embodiments, in a case where the first slice becomes congested in the core network, or the core network does not support the first slice, or the first slice is unavailable in the core network, the core network function may send one or more pieces of first information to the base station, to indicate replacement of the first slice with the one or more second slices indicated by the second slice information in the first information.

In some embodiments, the first information may include the second slice information configured to indicate the one or more second slices. The one or more second slices may be configured to replace the first slice currently serving the UE. In some other embodiments, the first information may include a mapping relationship between the first slice and the one or more second slices, such that the mapping relationship may indicate that the one or more second slices are configured to replace the first slice currently serving the UE. Alternatively, the first information may include the above-mentioned second slice information and/or the mapping relationship between the first slice and the one or more second slices.

In some embodiments, the operation of sending, by the core network function, the one or more pieces of first information to the base station may include: in a case where the first slice becomes congested in the core network or the core network does not support the first slice, sending, by the core network function, a first message to the base station, where the first message includes the one or more pieces of first information; or sending, by the core network function, a plurality of first messages to the base station, where each message includes one of the one or more pieces of first information.

In some embodiments, the core network function may carry the one or more pieces of first information (i.e., one or more pieces of second slice information) via one message. In some embodiments, the core network function may carry the one or more pieces of first information via a plurality of messages, and each of the plurality of messages may carry one piece of first information (i.e., one piece of second slice information).

In some embodiments, in the first message, a first information function (IE) configured to carry Single Network Slice Selection Assistance Information (S-NSSAI) may be configured to carry one piece of second slice information. Alternatively, a second information function (IE) in the first message may be configured to carry one piece of second slice information. The second information function (IE) may be different from the first information function (IE).

In some embodiments, as one implementation, the one or more pieces of second slice information may be carried via the first IE in the S-NSSAI, where the first IE may be an existing IE in the S-NSSAI. As another implementation, without modifying existing IEs in the S-NSSAI, a new IE (e.g., a second IE) may be defined, and the one or more pieces of second slice information may be carried via one or more said new IEs (e.g., the second IE). In some embodiments, the above-mentioned first IE or second IE may further include description information. The description information may describe that the one or more second slices indicated by the second slice information are configured to replace the first slice.

In some embodiments, the one or more second slices indicated by the second slice information may be embodied by a slice identifier (e.g., an identifier of the one or more second slices).

In some embodiments, the first message may be one of the following:
a PDU session resource modify request message;
a PDU session resource setup request message; or
a path switch request acknowledgement message.

In some embodiments, in a case where the core network function determines that the first slice becomes congested in the core network, or the core network does not support the first slice, or the first slice is unavailable in the core network, as one implementation, if the core network function decides not to re-establish the PDU session, the core network function may send a PDU session resource modify request message (which may also be referred to as a PDU session modify request message). The message may carry the one or more pieces of second slice information. As another implementation, if the core network function decides to re-establish the PDU session, the core network function may send a PDU session resource setup request message (which may also be referred to as a PDU session setup request message). The message may carry the one or more pieces of second slice information. As yet another implementation, in a scenario where some embodiments of the present disclosure are applied to a base station handover (i.e., in a scenario where the target base station sends a path switch request message to the core network function), the core network function may send a path switch request acknowledgement message. The message may carry the one or more pieces of second slice information. In some other embodiments, the one or more pieces of first information (or the one or more pieces of second slice information) may also be carried via other messages or newly defined messages.

In some embodiments, in a scenario where some embodiments of the present disclosure are not applied to the base station handover, the base station may be a base station associated with the UE, which may also be referred to as a serving base station. In some other embodiments, in a scenario where some embodiments of the present disclosure are applied to the base station handover, the base station may be a source base station or a target base station associated with the UE.

In some embodiments of the present disclosure, the first information may further include a first slice replacement cause and/or a priority associated with the one or more second slices.

In some embodiments, the first slice replacement cause may include at least one of the following:
the first slice in a core network becoming congested;
the core network not supporting the first slice;
the first slice being unavailable in the core network; or
network performance of the first slice being unable to satisfy a current Service Level Agreement (SLA).

In some embodiments, the core network function may determine a priority of a slice based on resource utilization of slices or based on a guarantee configuration status of the slices for a quality of service (QoS) requirement. In some embodiments, the core network function may determine the priority associated with the one or more second slices.

In some embodiments, before the sending, by the core network function, the one or more pieces of first information to the base station, the method may further include: configuring, by the core network function, the priority associated with the one or more second slices based on resource utilization of slices; or configuring, by the core network function, the priority associated with the one or more second slices based on a guarantee status of the slices for a QoS requirement.

In some embodiments, the priority of the slices (e.g., the one or more second slices may be related to or associated with the resource utilization of the slices or the guarantee status of the slices for the QoS requirement. In some embodiments, as one implementation, in a case where the slices (e.g., the one or more second slices) do not utilize excessive resources in the core network or the base station, i.e., in a case where the resource utilization (or resource usage rate) of the slices is not high, the slices may be configured with a higher priority. That is, the lower the resource utilization (or resource usage rate) of the slices in the core network or the base station, the higher the priority associated with the slices. Conversely, the higher the resource utilization (or resource usage rate) of the slices in the core network or the base station, the lower the priority associated with the slices. As another implementation, in a case where the slices (e.g., the one or more second slices) may ensure or guarantee that the QoS requirement of a service is not degraded after replacement, the slices may be configured with a higher priority. In a case where the slices (e.g., the one or more second slices) do not ensure or guarantee that the QoS requirement of the service is not degraded after replacement, i.e., in a case where the QoS requirement of the service is degraded, the slices may be configured with a lower priority. In some embodiments, the priority associated with the one or more second slices may be configured by the base station to select an alternative slice for the terminal.

In some embodiments of the present disclosure, in a case where the core network function sends a plurality of pieces of first information to the base station, i.e., in a case where the core network function indicates a plurality of pieces of second slice information to the base station, the method may further include: receiving, by the core network function, acknowledgement information sent by the base station. The acknowledgement information may include information related to or associated with the one or more second slices or the alternative slice selected by the base station from the plurality of pieces of second slice information. That is, the base station may inform the core network function of information related to or associated with the selected alternative slice via the acknowledgement information.

In some embodiments of the present disclosure, as shown in FIG. 2, the method may further include an operation 102.

At the operation 102, in a case where the first slice in the core network is not congested or the core network re-supports the first slice, the core network function may send second information to the base station. The second information may include first slice information configured to indicate the first slice, and/or the second information may include a mapping relationship between the first slice and the one or more second slices.

In some embodiments of the present disclosure, the core network function (which may be referred to as a first core network function) or a network management device may detect congestion of the slice in the core network or alleviation of the congestion, or may detect whether the core network supports the slice serving the UE. The first core network function may be the same as or different from the core network function that performs the technical solutions of various embodiments of the present disclosure. In a case where the first core network function or the network management device detects that the slice (e.g., the first slice) becomes congested or is not congested in the core network, or in a case where the first core network function or the network management device detects whether the core network supports the slice (e.g., the first slice), the detection result may be sent to the core network function. In this case, some embodiments of the present disclosure may be performed by the core network function. In some embodiments, for example, the first core network function may be a Network Slice Selection Function (NSSF) or the like, which will not be elaborated in the present disclosure.

In some embodiments, the slice currently serving the UE is the second slice (which may be a slice selected by the base station from the one or more second slices). In a case where the core network function learns that the first slice in the core network is not congested or the core network re-supports the first slice serving the UE, the core network function may send second information to the base station. The second information may include first slice information configured to indicate the first slice, and/or the second information may include a mapping relationship between the first slice and the one or more second slices. The second information may be configured to indicate that the base station switches back to the first slice or that the first slice replaces the one or more second slices currently serving the UE.

In some embodiments, the first slice indicated by the first slice information may be embodied by a slice identifier (e.g., an identifier of the first slice). The mapping relationship between the first slice and the one or more second slices may be embodied by a mapping relationship associated with the slice identifier.

In some embodiments, the second information may further include a second slice replacement cause, and the second slice replacement cause may include at least one of the following:
the first slice in the core network being not congested;
the core network re-supporting the first slice;
the first slice being available in the core network; or
the network performance of the first slice re-satisfying the current SLA.

In some embodiments of the present disclosure, before the core network function sends the one or more pieces of first information to the base station, the method may further include: receiving, by the core network function, third information sent by the base station. The third information may include one or more pieces of third slice information. A third slice indicated by the one or more pieces of third slice information may be an alternative slice selected by the base station for the UE.

In some embodiments, before the core network function informs the base station of the one or more pieces of first information, and in a case where the current first slice becomes congested in the core network, or the core network does not support the first slice currently serving the UE, or the first slice is unavailable in the core network (i.e., before the core network function sends the one or more pieces of first information to the base station), the base station may send the third information to the core network function. The third information may include one or more pieces of third slice information. A third slice indicated by each of the one or more pieces of third slice information may be an alternative slice selected by the base station for the UE. In a case where the core network supports the third slice, the core network function may select one or more slices from one or more third slices as the one or more second slices.

In some embodiments, for example, the above-mentioned base station may be a target base station. Before the core network function sends the one or more pieces of first information to the target base station, and in a case where the current first slice becomes congested in the core network or the core network does not support the first slice currently serving the UE, the target base station may send the third information to the core network function during the handover procedure. In this way, the target base station may inform the core network function of the alternative slice (e.g., the third slice) selected by the target base station for the UE. The alternative slice may also be referred to as a candidate slice.

In some embodiments, the operation of receiving, by the core network function, the third information sent by the base station may include: receiving, by the core network function, a second message sent by the base station. The second message may include the third information. For example, the second message may be a path switch request message. In some other embodiments, the base station may also send the third information via other messages or newly defined messages.

In some embodiments, the method may further include: in a case where the core network does not support the third slice, selecting, by the core network function, one or more slices from slices supported by the UE as the one or more second slices.

In some embodiments, in a case where the core network does not support any slice selected by the base station, the core network function may select one or more slices from slices supported by the UE as the one or more second slices. For example, the core network function may select one or more slices for the UE from the Allowed NSSAI as the one or more second slices.

In some embodiments of the present disclosure, as shown in FIG. 3, the method may further include an operation 103.

At the operation 103, the core network function may send fourth information to th base station after a first time expires. The fourth information may be configured to request to establish or re-establish a PDU session associated with the first slice or request to modify a PDU session associated with a current slice. The fourth information may include first slice information configured to indicate the first slice. The first time may be a time predicted by the core network function at which the first slice in the core network is not congested or at which the first slice becomes available in the core network.

In some embodiments, the core network function may predict the first time at which the first slice in the core network is not congested or at which the core network re-supports the first slice. That is, the core network function may predict that, after the first time (e.g., after a period of time starting from a moment or time point when the one or more pieces of first information are sent, where the period of time is the first time), or at a certain future time point, the first slice in the core network is not congested or the core network re-supports the first slice. At this time, the core network function may store and record, or maintain the first time. For example, after the core network function sends the one or more pieces of first information, the core network function may start a timer. The timing duration of the timer may be the first time. In this case, after the first time expires, or when the timing duration of the timer expires, the core network function may send the fourth information to the base station.

In some embodiments, the fourth information may be configured to request to establish or re-establish the PDU session associated with the first slice (or request to establish or re-establish a PDU session resource associated with the first slice) or request to modify the PDU session associated with the current slice (or request to modify the PDU session resource associated with the current slice). In some embodiments, the fourth information may include first slice information configured to indicate the first slice, and the first slice may be configured to replace the one or more second slices currently serving the UE. In some other embodiments, the fourth information may also include a mapping relationship between the first slice and the one or more second slices. In this way, the fourth information may be configured to indicate that the first slice is configured to replace the one or more second slices currently serving the UE via the mapping relationship.

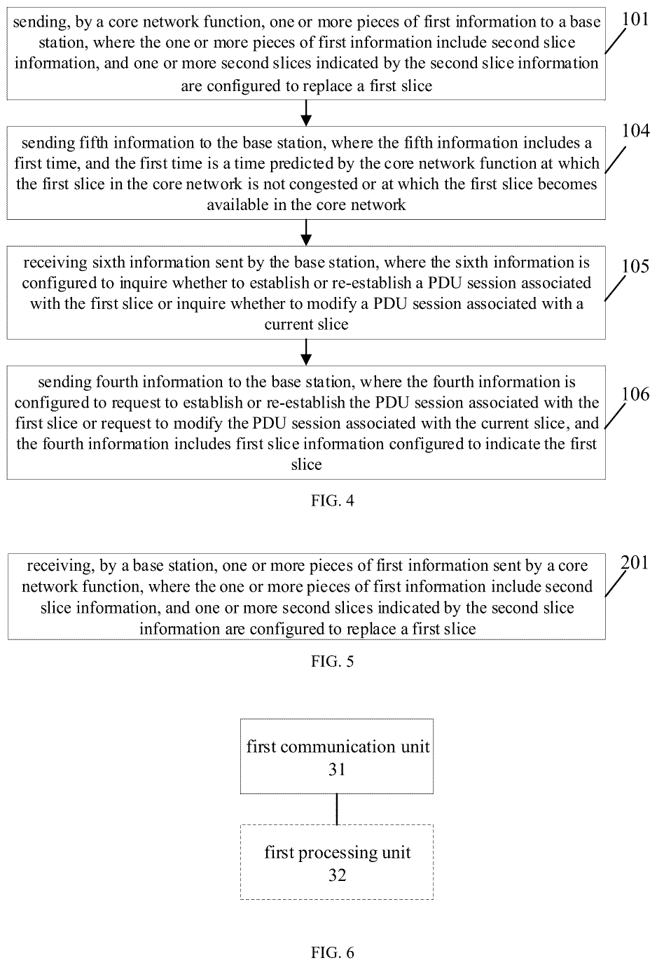

In some other embodiments of the present disclosure, as shown in FIG. 4, the method may further include operations 104 to 106.

At the operation 104, the core network function may send fifth information to the base station. The fifth information may include a first time. The first time may be a time predicted by the core network function at which the first slice in the core network is not congested or at which the first slice becomes available in the core network.

At the operation 105, the core network function may receive sixth information sent by the base station. The sixth information may be configured to inquire whether to establish or re-establish a PDU session associated with the first slice or inquire whether to modify a PDU session associated with a current slice. The sixth information may be sent by the base station after the first time expires.

At the operation 106, the core network function may send fourth information to the base station. The fourth information may be configured to request to establish or re-establish the PDU session associated with the first slice or request to modify the PDU session associated with the current slice. The fourth information may include first slice information configured to indicate the first slice.

In some embodiments, the core network function may predict the first time at which the first slice in the core network is not congested or at which the core network re-supports the first slice. That is, the core network function may predict that, after the first time (e.g., after a period of time starting from a moment or time point when the one or more pieces of first information are sent, where the period of time is the first time), or at a certain future time point, the first slice in the core network is not congested or the core network re-supports the first slice. The core network function may send the first time to the base station via fifth information. The base station may determine, based on the first time, that the first slice in the core network is not congested or the core network re-supports the first slice after the first time or at the future time point. The base station may further send the sixth information to the core network function after the first time expires. In this case, after the core network function receives the sixth information, the core network function may send the fourth information to the base station.

In some embodiments, the fourth information may be configured to request to establish or re-establish the PDU session associated with the first slice (or request to establish or re-establish the PDU session resource associated with the first slice) or request to modify the PDU session associated with the current slice (or request to modify the PDU session resource associated with the current slice). In some embodiments, the fourth information may include first slice information configured to indicate the first slice, and the first slice may be configured to replace the one or more second slices currently serving the UE. In some other embodiments, the fourth information may also include a mapping relationship between the first slice and the one or more second slices. In this way, the fourth information may be configured to indicate that the first slice is configured to replace the one or more second slices currently serving the UE via the mapping relationship.

In some embodiments of the present disclosure, the method may further include: sending, by the core network function, seventh information to the base station after a second time expires. The seventh information may be configured to request to establish or re-establish a PDU session associated with the first slice or request to modify a PDU session associated with a current slice. The seventh information may include first slice information configured to indicate the first slice. The second time may be a time predicted by the core network function at which the one or more second slices become congested in the core network or at which the one or more second slices become unavailable in the core network.

In some embodiments, slices currently serving the UE are the one or more second slices. The core network device may predict the second time at which the one or more second slices become congested in the core network or at which the one or more second slices become unavailable in the core network. That is, the core network function may predict that, after the second time (e.g., after a period of time starting from a moment or time point when the one or more pieces of first information are sent, where the period of time is the second time; or after a period of time starting from a moment or time point when the core network function receives feedback from the base station indicating that one of the one or more second slices has been selected to replace the first slice, where the period of time is the second time), or at a certain future time point, the one or more second slices become congested in the core network or the one or more second slices become unavailable in the core network. At this time, the core network function may store and record, or maintain the second time. For example, after the core network function sends the one or more pieces of first information, or after the core network function receives feedback from the base station indicating that one of the one or more second slices has been selected to replace the first slice, the core network function may start a timer according to the second time. The timing duration of the timer may be the second time. In this case, after the second time expires, or when the timing duration of the timer expires, the core network function may send the seventh information to the base station.

In some embodiments, the seventh information may be configured to request to establish or re-establish a PDU session associated with the first slice (or request to establish or re-establish a PDU session resource associated with the first slice) or request to modify a PDU session associated with a current slice (or request to modify the PDU session resource associated with the current slice). In some embodiments, the current slice may refer to the one or more second slices.

As an implementation, some embodiments may be applicable to a scenario where the base station has selected one second slice from the one or more second slices to replace the first slice. That is, the slice currently serving the UE may be the second slice. In this case, the above-mentioned second time may represent a time at which the one or more second slices currently serving the UE become congested in the core network or become unavailable in the core network. In some other embodiments, the one or more second slices associated with the second time may also be any slice or a specific slice of the one or more second slices associated with the above-mentioned one or more pieces of second slice information.

In some other embodiments of the present disclosure, the method may further include: sending, by the core network function, eighth information to the base station. The eighth information may include a second time. The second time may be a time predicted by the core network function at which the one or more second slices become congested in the core network or at which the one or more second slices become unavailable in the core network.

In some other embodiments of the present disclosure, the method may further include: receiving, by the core network function, ninth information sent by the base station, where the ninth information is configured to inquire whether to establish or re-establish a PDU session associated with the first slice or inquire whether to modify a PDU session associated with a current slice, and the ninth information is sent by the base station after the second time expires; and sending, by the core network function, seventh information to the base station, where the seventh information is configured to request to establish or re-establish the PDU session associated with the first slice or request to modify the PDU session associated with the current slice, and the seventh information includes first slice information configured to indicate the first slice.

In some embodiments, slices currently serving the UE are the one or more second slices. The core network device may predict the second time at which the one or more second slices become congested in the core network or at which the one or more second slices become unavailable in the core network. That is, the core network function may predict that, after the second time (e.g., after a period of time starting from a moment or time point when the one or more pieces of first information are sent, where the period of time is the second time; or after a period of time starting from a moment or time point when the core network function receives feedback from the base station indicating that one of the one or more second slices has been selected to replace the first slice, where the period of time is the second time), or at a certain future time point, the one or more second slices become congested in the core network or the one or more second slices become unavailable in the core network. At this time, the core network function may send the second time to the base station via the eighth information. The base station may determine, based on the second time, that the one or more second slices become congested in the core network or the one or more second slices become unavailable in the core network after the second time or at the future time point. The base station may send the ninth information to the core network function after the second time expires. In this case, after the core network function receives the ninth information, the core network function may send seventh information to the base station.

In some embodiments, the seventh information may be configured to request to establish or re-establish the PDU session associated with the first slice (or request to establish or re-establish the PDU session resource associated with the first slice) or request to modify the PDU session associated with the current slice (or request to modify the PDU session resource associated with the current slice). In some embodiments, the current slice may refer to the one or more second slices.

As an implementation, some embodiments may be applicable to a scenario where the base station has selected one second slice from the one or more second slices to replace the first slice. That is, the slice currently serving the UE may be the second slice. In this case, the above-mentioned second time may represent a time at which the one or more second slices currently serving the UE become congested in the core network or become unavailable in the core network. In some other embodiments, the one or more second slices associated with the second time may also be any slice or a specific slice of the one or more second slices associated with the above-mentioned one or more pieces of second slice information.

In some embodiments of the present disclosure, before the sending, by the core network function, the one or more pieces of first information to the base station, the method may further include: preferentially selecting, by the core network function, the one or more second slices without degradation of a slice QoS level of a UE.

In some embodiments, in a case where the first slice becomes congested in the core network or the core network does not support the first slice, the core network function may preferentially select one or more second slices capable of ensuring that the slice QoS level of the UE is not degraded.

In some embodiments, before the preferentially selecting, by the core network function, the one or more second slices without the degradation of the slice QoS level of the UE, the method may further include: sending, by the core network function, tenth information to the UE, where the tenth information is configured to inquire whether the UE accepts or not accepts the degradation of the slice QoS level; and receiving, by the core network function, eleventh information sent by the UE, where the eleventh information is configured to indicate or inform whether the UE accepts or not accepts the degradation of the slice QoS level.

In some embodiments, before the preferentially selecting, by the core network function, the one or more second slices without the degradation of the slice QoS level of the UE, the core network function may inquire whether the UE accepts the degradation of the slice QoS level via interaction with the UE. The UE may acknowledge the inquiry from the core network function via the eleventh information. The eleventh information may be configured to indicate or inform whether the UE accepts or not accepts the degradation of the slice QoS level. In a case where the eleventh information does not accept the degradation of the slice QoS level, the core network function needs to select one or more second slices capable of ensuring that the slice QoS level is not degraded.

Based on the above-mentioned embodiments, some embodiments of the present disclosure provide a slice information transmission method. FIG. 5 is a fifth schematic flowchart of a slice information transmission method according to some embodiments of the present disclosure. As shown in FIG. 5, the method includes an operation 201.

At the operation 201, a base station may receive one or more pieces of first information sent by a core network function. The one or more pieces of first information may include second slice information. One or more second slices indicated by the second slice information may be configured to replace a first slice.

In some embodiments, the first slice may be a slice currently serving the UE before or at the time when the base station receives the one or more pieces of first information sent by the core network function. The one or more second slices may be alternative slices indicated by the core network function to replace the first slice. In some embodiments, in a case where the first slice becomes congested in the core network, or the core network does not support the first slice, the base station may receive the one or more pieces of first information sent by the core network function, to indicate the base station to replace the first slice with the one or more second slices indicated by the second slice information in the first information.

In some embodiments, the first information may include the second slice information configured to indicate the one or more second slices. The one or more second slices may be configured to replace the first slice currently serving the UE. In some other embodiments, the first information may include a mapping relationship between the first slice and the one or more second slices, such that the mapping relationship may indicate that the one or more second slices are configured to replace the first slice currently serving the UE.

In some embodiments, the operation of receiving, by the base station, the one or more pieces of first information sent by the core network function may include: in a case where the first slice becomes congested in the core network or the core network does not support the first slice, receiving, by the base station, a first message sent by the core network function, where the first message includes the one or more pieces of first information; or receiving, by the base station, a plurality of first messages sent by the core network function, where each message includes one of the one or more pieces of first information.

In some embodiments, the core network function may carry the one or more pieces of first information (i.e., one or more pieces of second slice information) via one message. In some embodiments, the core network function may carry the one or more pieces of first information via a plurality of messages, and each of the plurality of messages may carry one piece of first information (i.e., one piece of second slice information).

In some embodiments, in the first message, a first information function (IE) configured to carry the S-NSSAI may be configured to carry one piece of second slice information. Alternatively, a second information function (IE) in the first message may be configured to carry one piece of second slice information. The second information function (IE) may be different from the first information function (IE).

In some embodiments, as one implementation, the one or more pieces of second slice information may be carried via the first IE in the S-NSSAI, where the first IE may be an existing IE in the S-NSSAI. As another implementation, without modifying existing IEs in the S-NSSAI, a new IE (e.g., a second IE) may be defined, and the one or more pieces of second slice information may be carried via one or more said new IEs (e.g., the second IE). In some embodiments, the above-mentioned first IE or second IE may further include description information. The description information may describe that the one or more second slices indicated by the second slice information are configured to replace the first slice.

In some embodiments, the one or more second slices indicated by the second slice information may be embodied by a slice identifier (e.g., an identifier of the one or more second slices).

In some embodiments, the first message may be one of the following:
a PDU session resource modify request message;
a PDU session resource setup request message; or
a path switch request acknowledgement message.

In some embodiments, in a case where the core network function determines that the first slice becomes congested in a core network, or the core network does not support the first slice, as one implementation, if the core network function decides not to re-establish the PDU session, the core network function may send a PDU session resource modify request message (which may also be referred to as a PDU session modify request message). That is, the base station may receive the PDU session resource modify request message (which may also be referred to as the PDU session modify request message) sent by the core network function, and the message may carry the one or more pieces of second slice information. As another implementation, if the core network function decides to re-establish the PDU session, the core network function may send a PDU session resource setup request message (which may also be referred to as a PDU session setup request message). That is, the base station may receive the PDU session resource setup request message (which may also be referred to as the PDU session setup request message) sent by the core network function. The message may carry the one or more pieces of second slice information. As yet another implementation, in a scenario where some embodiments of the present disclosure are applied to a base station handover (i.e., in a scenario where the target base station sends a path switch request message to the core network function), the core network function may send a path switch request acknowledgement message. That is, the base station may receive the path switch request acknowledgement message sent by the core network function, and the message may carry the one or more pieces of second slice information. In some other embodiments, the one or more pieces of first information (or the one or more pieces of second slice information) may also be carried via other messages or newly defined messages.

In some embodiments, in a scenario where some embodiments of the present disclosure are not applied to the base station handover, the base station may be a base station associated with the UE, which may also be referred to as a serving base station. In some other embodiments, in a scenario where some embodiments of the present disclosure are applied to the base station handover, the base station may be a source base station or a target base station associated with the UE.

In some embodiments of the present disclosure, the first information may further include a first slice replacement cause and/or a priority associated with the one or more second slices.

In some embodiments, the first slice replacement cause may include at least one of the following:
the first slice in a core network becoming congested;
the core network not supporting the first slice;
the first slice being unavailable in the core network; or
network performance of the first slice being unable to satisfy a current SLA.

In some embodiments, the priority associated with the one or more second slices may be determined by the core network function based on resource utilization of slices or based on a guarantee configuration status of the slices for a service QoS requirement.

In some embodiments, after the base station receives the one or more pieces of first information, the base station may select one or more second slices therefrom to replace the first slice currently serving the UE, establish a PDU session associated with the one or more second slices, or modify the PDU session currently serving the UE, such that the PDU session currently serving the UE may be associated with the selected one or more second slices. That is, the selected one or more second slices may be switched to be the slices currently serving the UE.

In some embodiments of the present disclosure, the method may further include: in case where the first slice in the core network is not congested or the core network re-supports the first slice, receiving, by the base station, second information sent by the core network function. The second information may include first slice information configured to indicate the first slice, and/or the second information may include a mapping relationship between the first slice and the one or more second slices.

In some embodiments, the slice currently serving the UE is the second slice (which may be a slice selected by the base station from the one or more second slices). In a case where the core network function learns that the first slice in the core network is not congested or the core network re-supports the first slice serving the UE, the core network function may send second information to the base station. The second information may include first slice information configured to indicate the first slice, and/or the second information may include a mapping relationship between the first slice and the one or more second slices. The second information may be configured to indicate that the base station switches back to the first slice or that the first slice replaces the one or more second slices currently serving the UE. In this case, after the base station receives the second information, the base station may establish or re-establish the PDU session associated with the first slice, or modify the PDU session currently serving the UE, such that the PDU session currently serving the UE may be associated with the first slice. That is, the first slice may be switched back to be the slice currently serving the UE.

In some embodiments, the first slice indicated by the first slice information may be embodied by a slice identifier (e.g., an identifier of the first slice). The mapping relationship between the first slice and the one or more second slices may be embodied by a mapping relationship associated with the slice identifier.

In some embodiments, the second information may further include a second slice replacement cause, and the second slice replacement cause may include at least one of the following:
the first slice in the core network being not congested;
the core network re-supporting the first slice;
the first slice being available in the core network; or
the network performance of the first slice re-satisfying the current SLA.

In some embodiments of the present disclosure, before the base station receives the one or more pieces of first information sent by the core network function, the method may further include: sending, by the base station, third information to the core network function. The third information may include one or more pieces of third slice information. A third slice indicated by the one or more pieces of third slice information may be an alternative slice selected by the base station for the UE.

In some embodiments, before the core network function sends the one or more pieces of first information to the base station, and in a case where the current first slice becomes congested in the core network or the core network does not support the first slice currently serving the UE (i.e., before the base station receives the one or more pieces of first information sent by the core network function), the base station may send the third information to the core network function. The third information may include one or more pieces of third slice information. A third slice indicated by each of the one or more pieces of third slice information may be an alternative slice selected by the base station for the UE. In a case where the core network supports the third slice, the core network function may select one or more slices from one or more third slices as the one or more second slices.

For example, the above-mentioned base station may be a target base station. Before the core network function sends the one or more pieces of first information to the target base station, and in a case where the current first slice becomes congested in the core network or the core network does not support the first slice currently serving the UE, the target base station may send the third information to the core network function during the handover procedure. In this way, the target base station may inform the core network function of the alternative slice (e.g., the third slice) selected by the target base station for the UE. The alternative slice may also be referred to as a candidate slice.

In some embodiments, the operation of sending, by the base station, the third information to the core network function may further include: sending, by the base station, a second message to the core network function. The second message may include the third information. For example, the second message may be a path switch request message. In some other embodiments, the base station may also send the third information via other messages or newly defined messages.

In some embodiments of the present disclosure, the method may further include: receiving, by the base station, fourth information sent by the core network function. The fourth information may be configured to request to establish or re-establish a PDU session associated with the first slice or request to modify a PDU session associated with a current slice. The fourth information may include first slice information configured to indicate the first slice. The fourth information may be sent by the core network function after a first time expires. The first time may be a time predicted by the core network function at which the first slice in the core network is not congested or at which the first slice becomes available in the core network. In some embodiments, the fourth information may be sent by the core network function after the predicted first time expires.

In some embodiments, the core network function may predict the first time at which the first slice in the core network is not congested or at which the core network re-supports the first slice. That is, the core network function may predict that, after the first time (e.g., after a period of time starting from a moment or time point when the one or more pieces of first information are sent, where the period of time is the first time), or at a certain future time point, the first slice in the core network is not congested or the core network re-supports the first slice. The core network function may store and record, or maintain the first time. For example, after the core network function sends the one or more pieces of first information, the core network function may start a timer. The timing duration of the timer may be the first time. In this case, after the first time expires, or when the timing duration of the timer expires, the core network function may send the fourth information to the base station. After the base station receives the fourth information, the base station may establish or re-establish the PDU session associated with the first slice or modify the PDU session associated with the current slice.

In some embodiments, the fourth information may be configured to request to establish or re-establish the PDU session associated with the first slice (or request to establish or re-establish the PDU session resource associated with the first slice) or request to modify the PDU session associated with the current slice (or request to modify the PDU session resource associated with the current slice). In some embodiments, the fourth information may include first slice information configured to indicate the first slice, and the first slice may be configured to replace the one or more second slices currently serving the UE. In some other embodiments, the fourth information may also include a mapping relationship between the first slice and the one or more second slices. In this way, the fourth information may be configured to indicate that the first slice is configured to replace the one or more second slices currently serving the U E via the mapping relationship.

In some other embodiments of the present disclosure, the method may further include: receiving, by the base station, fifth information sent by the core network function. The fifth information may include a first time. The first time may be a time predicted by the core network function at which the first slice in the core network is not congested or at which the first slice becomes available in the core network.

In some embodiments, the method may further include: sending, by the base station, sixth information to the core network function after the first time expires, where the sixth information is configured to inquire whether to establish or re-establish a PDU session associated with the first slice or inquire whether to modify a PDU session associated with a current slice; and receiving, by the base station, fourth information sent by the core network function, where the fourth information is configured to request to establish or re-establish the PDU session associated with the first slice or request to modify the PDU session associated with the current slice, and the fourth information includes first slice information configured to indicate the first slice.

In some embodiments, the core network function may predict the first time at which the first slice in the core network is not congested or at which the core network re-supports the first slice. That is, the core network function may predict that, after the first time (e.g., after a period of time starting from a moment or time point when the one or more pieces of first information are sent, where the period of time is the first time), or at a certain future time point, the first slice in the core network is not congested or the core network re-supports the first slice. The core network function may send the first time to the base station via fifth information. The base station may determine, based on the first time, that the first slice in the core network is not congested or the core network re-supports the first slice after the first time or at the future time point. The base station may further send the sixth information to the core network function after the first time expires. In this case, after the core network function receives the sixth information, the core network function may send the fourth information to the base station. After the base station receives the fourth information, the base station may establish or re-establish the PDU session associated with the first slice or modify the PDU session associated with the current slice.

In some embodiments, after the base station receives the fifth information, the base station may start a timer. The timing duration of the timer may be the first time. In this case, after the first time expires, or when the timing duration of the timer expires, the base station may send the sixth information to the core network function.

In some embodiments, the fourth information may be configured to request to establish or re-establish the PDU session associated with the first slice (or request to establish or re-establish the PDU session resource associated with the first slice) or request to modify the PDU session associated with the current slice (or request to modify the PDU session resource associated with the current slice). In some embodiments, the fourth information may include first slice information configured to indicate the first slice, and the first slice may be configured to replace the one or more second slices currently serving the UE. In some other embodiments, the fourth information may also include a mapping relationship between the first slice and the one or more second slices. In this way, the fourth information may be configured to indicate that the first slice is configured to replace the one or more second slices currently serving the UE via the mapping relationship.

In some embodiments of the present disclosure, the method may further include: receiving, by the base station, seventh information sent by the core network function. The seventh information may be configured to request to establish or re-establish a PDU session associated with the first slice or request to modify a PDU session associated with a current slice. The seventh information may include first slice information configured to indicate the first slice. The seventh information may be sent by the core network function after a second time expires. The second time may be a time predicted by the core network function at which the one or more second slices become congested in the core network or at which the one or more second slices become unavailable in the core network.

In some embodiments, slices currently serving the UE are the one or more second slices. The core network device may predict the second time at which the one or more second slices become congested in the core network or at which the one or more second slices become unavailable in the core network. That is, the core network function may predict that, after the second time (e.g., after a period of time starting from a moment or time point when the core network function sends the one or more pieces of first information, where the period of time is the second time; or after a period of time starting from a moment or time point when the core network function receives feedback from the base station indicating that one of the one or more second slices has been selected to replace the first slice, where the period of time is the second time), or at a certain future time point, the one or more second slices become congested in the core network or the one or more second slices become unavailable in the core network. At this time, the core network function may store and record, or maintain the second time. For example, after the core network function sends the one or more pieces of first information, or after the core network function receives feedback from the base station indicating that one of the one or more second slices has been selected to replace the first slice, the core network function may start a timer according to the second time. The timing duration of the timer may be the second time. In this case, after the second time expires, or when the timing duration of the timer expires, the core network function may send the seventh information to the base station. After the base station receives the seventh information, the base station may establish or re-establish the PDU session associated with the first slice or modify the PDU session associated with the current slice.

In some embodiments, the seventh information may be configured to request to establish or re-establish a PDU session associated with the first slice (or request to establish or re-establish a PDU session resource associated with the first slice) or request to modify a PDU session associated with a current slice (or request to modify the PDU session resource associated with the current slice). In some embodiments, the current slice may refer to the one or more second slices.

In some other embodiments of the present disclosure, the method may further include: receiving, by the base station, eighth information sent by the core network function. The eighth information may include a second time. The second time may be a time predicted by the core network function at which the one or more second slices become congested in the core network or at which the one or more second slices become unavailable in the core network.

In some embodiments, the method may further include: sending, by the base station, ninth information to the core network function after the second time expires, where the ninth information is configured to inquire whether to establish or re-establish a PDU session associated with the first slice or inquire whether to modify a PDU session associated with a current slice; and receiving, by the base station, seventh information sent by the core network function, where the seventh information is configured to request to establish or re-establish the PDU session associated with the first slice or request to modify the PDU session associated with the current slice, and the seventh information includes first slice information configured to indicate the first slice.

In some embodiments, the core network device may predict the second time at which the one or more second slices become congested in the core network in the future or at which the core network does not support the one or more second slices in the future. That is, the core network function may predict that, after the second time (e.g., after a period of time starting from a moment or time point when the one or more pieces of first information are sent, where the period of time is the second time; or after a period of time starting from a moment or time point when the core network function receives feedback from the base station indicating that one of the one or more second slices has been selected to replace the first slice, where the period of time is the second time), or at a certain future time point, the one or more second slices become congested in the core network or the one or more second slices become unavailable in the core network. At this time, the core network function may send the second time to the base station via the eighth information. The base station may determine, based on the second time, that the one or more second slices become congested in the core network or the one or more second slices become unavailable in the core network after the second time or at the future time point. The base station may send the ninth information to the core network function. In this case, after the core network function receives the ninth information, the core network function may send seventh information to the base station. After the base station receives the seventh information, the base station may establish or re-establish the PDU session associated with the first slice or modify the PDU session associated with the current slice.

In some embodiments, after the base station receives the eighth information, the base station may start a timer. The timing duration of the timer may be the second time. In this case, after the second time expires, or when the timing duration of the timer expires, the base station may send the ninth information to the core network function.

In some embodiments, the seventh information may be configured to request to establish or re-establish the PDU session associated with the first slice (or request to establish or re-establish the PDU session resource associated with the first slice) or request to modify the PDU session associated with the current slice (or request to modify the PDU session resource associated with the current slice). In some embodiments, the current slice may refer to the one or more second slices.

Based on the above embodiments of the method, some embodiments of the present disclosure further provide a slice information transmission apparatus. The slice information transmission apparatus is applied to or configured in a core network function. FIG. 6 is a first structural schematic diagram of a slice information transmission apparatus according to some embodiments of the present disclosure. As shown in FIG. 6, the apparatus includes a first communication unit 31. The first communication unit 31 may be configured to send one or more pieces of first information to a base station. The one or more pieces of first information may include second slice information. One or more second slices indicated by the second slice information may be configured to replace a first slice.

In some embodiments of the present disclosure, the first information may further include a first slice replacement cause and/or a priority associated with the one or more second slices.

In some embodiments of the present disclosure, the first slice replacement cause may include at least one of the following:
the first slice in a core network becoming congested;
the core network not supporting the first slice;
the first slice being unavailable in the core network; or
network performance of the first slice being unable to satisfy a current SLA.

In some embodiments of the present disclosure, the apparatus may further include a first processing unit 32. The first processing unit 32 may be configured to: before the first communication unit 31 sends the one or more pieces of first information to the base station, configure the priority associated with the one or more second slices based on resource utilization of slices; or configure the priority associated with the one or more second slices based on a guarantee status of the slices for a QoS requirement.

In some embodiments of the present disclosure, the first communication unit 31 may be further configured to: in a case where the first slice in the core network is not congested or the core network re-supports the first slice, send second information to the base station. The second information may include first slice information configured to indicate the first slice, and/or the second information may include a mapping relationship between the first slice and the one or more second slices.

In some embodiments of the present disclosure, the second information may further include a second slice replacement cause. The second slice replacement cause may include at least one of the following:
the first slice in the core network being not congested;
the core network re-supporting the first slice;
the first slice being available in the core network; or
the network performance of the first slice re-satisfying the current SLA.

In some embodiments of the present disclosure, the first communication unit 31 may be further configured to, before sending the one or more pieces of first information to the base station, receive third information sent by the base station. The third information may include one or more pieces of third slice information. A third slice indicated by the one or more pieces of third slice information may be an alternative slice selected by the base station for the UE.

In some embodiments of the present disclosure, the apparatus may further include a first processing unit 32. The first processing unit 32 may be configured to, in a case where the core network does not support the third slice, select one or more slices from slices supported by the UE as the one or more second slices.

In some embodiments of the present disclosure, the first communication unit 31 may be further configured to send fourth information to the base station after a first time expires. The fourth information may be configured to request to establish or re-establish a PDU session associated with the first slice or to request to modify a PDU session associated with a current slice. The fourth information may include first slice information configured to indicate the first slice. The first time may be a time predicted by the core network function at which the first slice in the core network is not congested or at which the first slice becomes available in the core network.

In some embodiments of the present disclosure, the first communication unit 31 may be further configured to send fifth information to the base station. The fifth information may include a first time. The first time may be a time predicted by the core network function at which the first slice in the core network is not congested or at which the first slice becomes available in the core network.

In some embodiments of the present disclosure, the first communication unit 31 may be further configured to receive sixth information sent by the base station. The sixth information may be configured to inquire whether to establish or re-establish a PDU session associated with the first slice or inquire whether to modify a PDU session associated with a current slice. The sixth information may be sent by the base station after the first time expires. The first communication unit 31 may be further configured to send fourth information to the base station. The fourth information may be configured to request to establish or re-establish the PDU session associated with the first slice or request to modify the PDU session associated with the current slice. The fourth information may include first slice information configured to indicate the first slice.

In some embodiments of the present disclosure, the first communication unit 31 may be further configured to send seventh information to the base station after a second time expires. The seventh information may be configured to request to establish or re-establish a PDU session associated with the first slice or request to modify a PDU session associated with a current slice. The seventh information may include first slice information configured to indicate the first slice. The second time may be a time predicted by the core network function at which the one or more second slices become congested in the core network or at which the one or more second slices become unavailable in the core network.

In some embodiments of the present disclosure, the first communication unit 31 may be further configured to send eighth information to the base station. The eighth information may include a second time. The second time may be a time predicted by the core network function at which the one or more second slices become congested in the core network or at which the one or more second slices become unavailable in the core network.

In some embodiments of the present disclosure, the first communication unit 31 may be further configured to receive ninth information sent by the base station. The ninth information may be configured to inquire whether to establish or re-establish a PDU session associated with the first slice or inquire whether to modify a PDU session associated with a current slice. The ninth information may be sent by the base station after the second time expires. The first communication unit 31 may be further configured to send seventh information to the base station. The seventh information may be configured to request to establish or re-establish the PDU session associated with the first slice or request to modify the PDU session associated with the current slice. The seventh information may include first slice information configured to indicate the first slice.

In some embodiments of the present disclosure, the apparatus may further include a first processing unit 32. The first processing unit 32 may be configured to, before the first communication unit 31 sends the one or more pieces of first information to the base station, preferentially select the one or more second slices without degradation of a slice QoS level of a UE.

In some embodiments of the present disclosure, the first communication unit 31 may be further configured to: before the first processing unit 32 preferentially selects the one or more second slices without degradation of the slice QoS level of the UE, send tenth information to the UE, where the tenth information may be configured to inquire whether the UE accepts or not accepts the degradation of the slice QoS level; and receive eleventh information sent by the UE, where the eleventh information may be configured to indicate or inform whether the UE accepts or not accepts the degradation of the slice QoS level.

In some embodiments of the present disclosure, the first processing unit 32 of the apparatus may be implemented in practice by a Central Processing Unit (CPU), a Digital Signal Processor (DSP), a Microcontroller Unit (MCU), or a Field-Programmable Gate Array (FPGA). The first communication unit 31 of the apparatus may be implemented in practice by a communication module (including: a basic communication suite, an operating system, a communication module, a standardized interface and a protocol, etc.) and a transceiver antenna.

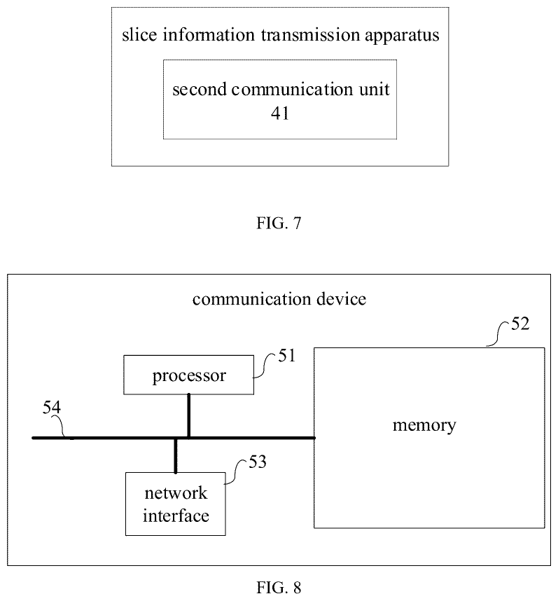

Some embodiments of the present disclosure may further provide a slice information transmission apparatus. The slice information transmission apparatus is applied to or configured in a base station. FIG. 7 is a second structural schematic diagram of a slice information transmission apparatus according to some embodiments of the present disclosure. As shown in FIG. 7, the apparatus includes: a second communication unit 41. The second communication unit 41 may be configured to receive one or more pieces of first information sent by a core network function. The one or more pieces of first information may include second slice information, and one or more second slices indicated by the second slice information are configured to replace a first slice.

In some embodiments of the present disclosure, the first information may further include a first slice replacement cause and/or a priority associated with the one or more second slices.

In some embodiments of the present disclosure, the first slice replacement cause may include at least one of the following:
the first slice in a core network becoming congested;
the core network not supporting the first slice;
the first slice being unavailable in the core network; or
network performance of the first slice being unable to satisfy a current SLA.

In some embodiments of the present disclosure, the second communication unit 41 may be further configured to, in a case where the first slice in the core network is not congested or the core network re-supports the first slice serving a UE, receive second information sent by the core network function. The second information may include first slice information configured to indicate the first slice, and/or the second information may include a mapping relationship between the first slice and the one or more second slices.

In some embodiments of the present disclosure, the second information may further include a second slice replacement cause. The second slice replacement cause may include at least one of the following:
the first slice in the core network being not congested;
the core network re-supporting the first slice;
the first slice being available in the core network; or
the network performance of the first slice re-satisfying the current SLA.

In some embodiments of the present disclosure, the second communication unit 41 may be further configured to, before receiving the one or more pieces of first information sent by the core network function, send third information to the core network function. The third information may include one or more pieces of third slice information. A third slice indicated by the one or more pieces of third slice information may be an alternative slice selected by the base station for the UE.

In some embodiments of the present disclosure, the second communication unit 41 may be further configured to receive fourth information sent by the core network function. The fourth information may be configured to request to establish or re-establish a PDU session associated with the first slice or request to modify a PDU session associated with a current slice. The fourth information may include first slice information configured to indicate the first slice. The fourth information may be sent by the core network function after a first time expires. The first time may be a time predicted by the core network function at which the first slice in the core network is not congested or at which the first slice becomes available in the core network.

In some embodiments of the present disclosure, the second communication unit 41 may be further configured to receive fifth information sent by the core network function. The fifth information may include a first time. The first time may be a time predicted by the core network function at which the first slice in the core network is not congested or at which the first slice becomes available in the core network.

In some embodiments of the present disclosure, the second communication unit 41 may be further configured to send sixth information to the core network function after the first time expires. The sixth information may be configured to inquire whether to establish or re-establish a PDU session associated with the first slice or inquire whether to modify a PDU session associated with a current slice. The second communication unit 41 may be further configured to receive fourth information sent by the core network function. The fourth information may be configured to request to establish or re-establish the PDU session associated with the first slice or request to modify the PDU session associated with the current slice. The fourth information may include first slice information configured to indicate the first slice.

In some embodiments of the present disclosure, the second communication unit 41 may be further configured to receive seventh information sent by the core network function. The seventh information may be configured to request to establish or re-establish a PDU session associated with the first slice or request to modify a PDU session associated with a current slice. The seventh information may include first slice information configured to indicate the first slice. The seventh information may be sent by the core network function after a second time expires. The second time may be a time predicted by the core network function at which the one or more second slices become congested in the core network or at which the one or more second slices become unavailable in the core network.

In some embodiments of the present disclosure, the second communication unit 41 may be further configured to receive eighth information sent by the core network function. The eighth information may include a second time. The second time may be a time predicted by the core network function at which the one or more second slices become congested in the core network or at which the one or more second slices become unavailable in the core network.

In some embodiments of the present disclosure, the second communication unit 41 may be further configured to send ninth information to the core network function after the second time expires. The ninth information may be configured to inquire whether to establish or re-establish a PDU session associated with the first slice or inquire whether to modify a PDU session associated with a current slice. The second communication unit 41 may be further configured to receive seventh information sent by the core network function. The seventh information may be configured to request to establish or re-establish the PDU session associated with the first slice or request to modify the PDU session associated with the current slice. The seventh information may include first slice information configured to indicate the first slice.

In some embodiments of the present disclosure, the second communication unit 41 of the apparatus may be implemented in practice by a communication module (including: a basic communication suite, an operating system, a communication module, a standardized interface and a protocol, etc.) and a transceiver antenna.

It should be noted that the slice information transmission apparatus provided in the above embodiments is only exemplified by a division of each of the above-described program modules when performing slice information transmission. In practical application, the above processing may be assigned to be completed by different program modules as needed, i.e., an internal structure of the apparatus may be divided into different program modules to complete all or part of the above processing. In addition, the slice information transmission apparatus provided in the above embodiments belongs to a same concept as some embodiments of the slice information transmission method, and the realization process is described in detail in some embodiments of the method, which will not be repeated herein.

Some embodiments of the present disclosure further provide a communication device. The communication device may be a core network function or a base station. FIG. 8 is a structural schematic diagram of hardware components of a communication device according to some embodiments of the present disclosure. As shown in FIG. 8, the communication device may include a memory 52, a processor 51, and a computer program stored on the memory 52 and executable on the processor 51. The processor may be configured to execute the computer program to perform the slice information transmission method applied to the core network function or the base station.

In some embodiments, the communication device may further include at least one network interface 53. In some embodiments, the components of the communication device may be coupled together via a bus system 54. It should be understood that the bus system 54 may be configured to realize connection and communication between the components. The bus system 54 may include a power bus, a control bus, and a state signal bus in addition to a data bus. However, for clarity of illustration, the various buses are labeled as the bus system 54 in FIG. 8.

It may be understood that, the memory 52 may be a volatile memory or a non-volatile memory, and may also include both the volatile memory and the non-volatile memory. In some embodiments, the non-volatile memory may be a Read Only Memory (ROM), a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a flash memory, a magnetic surface memory, an optical disk, or a Compact Disc Read-Only Memory (CD-ROM). The magnetic surface memory may be a magnetic disk memory or a magnetic tape memory. The volatile memory may be a Random Access Memory (RAM), which is used as an external cache. By way of illustration, but not limitation, a plurality of forms of RAMs are available, such as a Static Random Access Memory (SRAM), a Synchronous Static Random Access Memory (SSRAM), a Dynamic Random Access Memory (DRAM), a Synchronous Dynamic Random Access Memory (SDRAM), a Double Data Rate Synchronous Dynamic Random Access Memory (DDRSDRAM), an Enhanced Synchronous Dynamic Random Access Memory (ESDRAM), a Synclink Dynamic Random Access Memory (SLDRAM), and a Direct Rambus Random Access Memory (DRRAM). The memory 52 described in some embodiments of the present disclosure is intended to include, but not limited to, these and any other suitable types of memories.

The method disclosed in some embodiments of the present disclosure may be applied to the processor 51 implemented by the processor 51. The processor 51 may be an integrated circuit chip with a signal processing capability. In an implementation process, each operation of the above method may be completed by an integrated logic circuit of hardware or instructions in the form of software in the processor 51. The processor 51 may be a general processor, a DSP, or other programmable logic devices, discrete gates or transistor logic devices, discrete hardware components, etc. The processor 51 may implement or execute the methods, operations and logic blocks disclosed in some embodiments of the present disclosure. The general processor may be a microprocessor or any conventional processor, etc. The operations of the method disclosed in some embodiments of the disclosure may be executed and completed by a hardware decoding processor which is embodied directly or by a combination of hardware and software modules in the decoding processor. The software module may be located in a storage medium. The storage medium may be located in the memory 52. The processor 51 may read the information in the memory 52, and complete the operations of the above method in combination with the hardware.

In some embodiments, the communication device may be implemented by one or more Application Specific Integrated Circuits (ASICs), DSPs, Programmable Logic Devices (PLDs), Complex Programmable Logic Devices (CPLDs), FPGAs, general-purpose processors, controllers, MCUs, microprocessors, or other electronic components. The communication device may be configured to execute the above methods.

In an exemplary embodiment, some embodiments of the present disclosure further provide a computer-readable storage medium. For example, the computer-readable storage medium may include the memory 52 storing a computer program. The above computer program may be executed by the processor 51 of the communication device to perform the operations of the above methods. The computer-readable storage medium may be a memory as the FRAM, the ROM, the PROM, the EPROM, the EEPROM, the flash memory, the magnetic surface memory, the optical disk, the CD-ROM, or the like. The computer-readable storage medium may also be a variety of devices including one of the above memories or any combination thereof.

The computer-readable storage medium provided by some embodiments of the present disclosure may be configured to store a computer program that, when executed by a processor, operations of the slice information transmission method applied to or performed by the core network function or the base station of some embodiments of the present disclosure may be implemented.

Some embodiments of the present disclosure provide a slice information transmission method, a slice information transmission apparatus, a communication device, and a storage medium. The method includes: sending, by a core network function, one or more pieces of first information to a base station. The one or more pieces of first information include second slice information. One or more second slices indicated by the second slice information are configured to replace a first slice. By adopting the technical solutions of some embodiments of the present disclosure, the core network function may indicate information of the one or more second slices configured to replace the first slice, thereby addressing the problem of service failure of slice handover caused by inconsistent behavior between the core network and the base station regarding admission of a current slice, and ensuring service continuity.

The methods disclosed in the method embodiments according to the present disclosure may be arbitrarily combined without conflicts to obtain new method embodiments.

Features disclosed in the product embodiments according to the present disclosure may be arbitrarily combined without conflicts to obtain new product embodiments.

Features disclosed in the method embodiments or the apparatus embodiments according to the present disclosure may be arbitrarily combined without conflicts to obtain new method embodiments or apparatus embodiments.

In some embodiments provided in the present disclosure, it should be understood that the disclosed apparatus and method may be implemented in other ways. For example, the above apparatus embodiments are merely illustrative, such as division of units, only a logical function division. There may be additional division modes when actual implementation, such as a plurality of units or components may be combined or may be integrated into another system, or some features may be omitted, or not performed. In addition, the coupling, direct coupling, or communicatively connection among the various components shown or discussed components may be an indirect coupling or communicatively connection via some interfaces, devices, or units, which may be in electrical, mechanical, or other forms.

The above units described as separate components may be or may not be physically separated. The components shown as units may be or may not be physical units, which may be located in one place, or may be distributed to a plurality of network units. Part or all units may be selected according to the actual requirements to achieve the purpose of the present disclosure.

In addition, functional units in some embodiments of the present disclosure may be integrated in one processing unit, or may be physically existed separately, or two or more units may be integrated in one unit. The above integrated units may be implemented either in the form of hardware or in the form of hardware plus software function units.

Those skilled in the art may understand that, all or part of the operations of the above-mentioned method embodiments may be completed by hardware related to program instructions, and the above-mentioned programs may be stored in a computer-readable storage medium. When the programs are executed, the operations of the above-mentioned method embodiments are implemented. The above-mentioned storage medium includes various media that may store program codes, such as a mobile storage device, a ROM, a RAM, a magnetic disk or an optical disk.

Alternatively, if the above integrated units of the present disclosure are implemented in the form of a software function module, sold and used as an independent product, they may also be stored in a computer-readable storage medium. On the basis of such an understanding, the essential technical solution of the present disclosure, or a part of the technical solution contributing to the related art may be embodied in the form of a software product. The computer software product may be stored in a storage medium, including several instructions to enable a computer device (may be a personal computer, a server, a network device, etc.) to perform all or part of the operations in various embodiments of the present disclosure. The forgoing storage medium includes a mobile storage device, a ROM, a RAM, a magnetic disk, or an optical disk, and other media that may store program codes.

The above is merely specific embodiments of the present disclosure, but the scope of protection of the present disclosure is not limited thereto. Those skilled in the art may easily envisage changing or replacing within the technical scope disclosed in the present disclosure, which should be covered within the protection scope of the present disclosure. Therefore, the protection scope of the present disclosure shall be subject to the protection scope of the claim.

1. A slice information transmission method, performed by a core network function, comprising:
sending one or more pieces of first information to a base station, wherein the one or more pieces of first information comprise second slice information, and one or more second slices indicated by the second slice information are configured to replace a first slice.

2. The method as claimed in claim 1, wherein the one or more pieces of first information further comprise at least one of a first slice replacement cause or a priority associated with the one or more second slices.

3. The method as claimed in claim 2, wherein the first slice replacement cause comprises at least one of the following:
the first slice in a core network becoming congested;
the core network not supporting the first slice;
the first slice being unavailable in the core network; or
network performance of the first slice being unable to satisfy a current service level agreement (SLA).

4. The method as claimed in claim 2, wherein before sending the one or more pieces of first information to the base station, the method further comprises:
configuring the priority associated with the one or more second slices based on resource utilization of slices; or
configuring the priority associated with the one or more second slices based on a guarantee status of the slices for a quality of service requirement.

5. The method as claimed in claim 1, further comprising:
in a case where the first slice in a core network is not congested or the core network re-supports the first slice, sending second information to the base station;
wherein the second information comprises at least one of the following:
first slice information configured to indicate the first slice, or
a mapping relationship between the first slice and the one or more second slices.

6. The method as claimed in claim 5, wherein the second information further comprises a second slice replacement cause, and the second slice replacement cause comprises at least one of the following:
the first slice in the core network being not congested;
the core network re-supporting the first slice;
the first slice being available in the core network; or
the network performance of the first slice re-satisfying the current SLA.

7. The method as claimed in claim 1, wherein before sending the one or more pieces of first information to the base station, the method further comprises:
receiving third information sent by the base station, wherein the third information comprises one or more pieces of third slice information, and a third slice indicated by the one or more pieces of third slice information is an alternative slice selected by the base station for a user equipment (UE).

8. The method as claimed in claim 7, further comprising:
in a case where a core network does not support the third slice, selecting one or more slices from slices supported by the UE as the one or more second slices.

9. The method as claimed in claim 1, further comprising:
sending fourth information to the base station after a first time expires, wherein the fourth information is configured to request to establish or re-establish a protocol data unit (PDU) session associated with the first slice or to request to modify a PDU session associated with a slice currently serving a UE, and the fourth information comprises first slice information configured to indicate the first slice;
wherein the first time is a time predicted by the core network function at which the first slice in a core network is not congested or at which the first slice becomes available in the core network.

10. The method as claimed in claim 1, further comprising at least one of the following:
sending fifth information to the base station, wherein the fifth information comprises a first time, and the first time is a time predicted by the core network function at which the first slice in a core network is not congested or at which the first slice becomes available in the core network;
receiving sixth information sent by the base station, wherein the sixth information is configured to inquire whether to establish or re-establish a PDU session associated with the first slice or inquire whether to modify a PDU session associated with a slice currently serving a UE, and the sixth information is sent by the base station after the first time expires; or
sending fourth information to the base station, wherein the fourth information is configured to request to establish or re-establish the PDU session associated with the first slice or request to modify the PDU session associated with the slice currently serving the UE, and the fourth information comprises first slice information configured to indicate the first slice.

11. The method as claimed in claim 1, further comprising:
sending seventh information to the base station after a second time expires, wherein the seventh information is configured to request to establish or re-establish a PDU session associated with the first slice or request to modify a PDU session associated with a slice currently serving a UE, and the seventh information comprises first slice information configured to indicate the first slice;
wherein the second time is a time predicted by the core network function at which the one or more second slices become congested in a core network or at which the one or more second slices become unavailable in the core network.

12. The method as claimed in claim 1, further comprising at least one of the following:
sending eighth information to the base station, wherein the eighth information comprises a second time, and the second time is a time predicted by the core network function at which the one or more second slices become congested in a core network or at which the one or more second slices become unavailable in the core network;
receiving ninth information sent by the base station, wherein the ninth information is configured to inquire whether to establish or re-establish a PDU session associated with the first slice or inquire whether to modify a PDU session associated with a slice currently serving a UE, and the ninth information is sent by the base station after the second time expires; or
sending seventh information to the base station, wherein the seventh information is configured to request to establish or re-establish the PDU session associated with the first slice or request to modify the PDU session associated with the slice currently serving the UE, and the seventh information comprises first slice information configured to indicate the first slice.

13. The method as claimed in claim 1, wherein before sending the one or more pieces of first information to the base station, the method further comprises:
preferentially selecting the one or more second slices without degradation of a slice quality of service level of a user equipment (UE).

14. The method as claimed in claim 13, wherein before preferentially selecting the one or more second slices without degradation of the slice quality of service level of the UE, the method further comprises:
sending tenth information to the UE, wherein the tenth information is configured to inquire whether to accept or not accept the degradation of the slice quality of service level; and
receiving eleventh information sent by the UE, wherein the eleventh information is configured to indicate or inform whether to accept or not accept the degradation of the slice quality of service level.

15. A slice information transmission method, performed by a base station, comprising:
receiving one or more pieces of first information sent by a core network function, wherein the one or more pieces of first information comprise second slice information, and one or more second slices indicated by the second slice information are configured to replace a first slice.

16. The method as claimed in claim 15, further comprising:
in a case where the first slice in a core network is not congested or the core network re-supports the first slice serving a user equipment (UE), receiving second information sent by the core network function;
wherein the second information comprises at least one of the following:
first slice information configured to indicate the first slice, or
a mapping relationship between the first slice and the one or more second slices.

17. The method as claimed in claim 15, wherein before receiving the one or more pieces of first information sent by the core network function, the method further comprises:
sending third information to the core network function, wherein the third information comprises one or more pieces of third slice information, and a third slice indicated by the one or more pieces of third slice information is an alternative slice selected by the base station for a UE.

18. The method as claimed in claim 15, further comprising:
receiving fourth information sent by the core network function, wherein the fourth information is configured to request to establish or re-establish a protocol data unit (PDU) session associated with the first slice or request to modify a PDU session associated with a slice currently serving a UE, and the fourth information comprises first slice information configured to indicate the first slice;
wherein the fourth information is sent by the core network function after a first time expires, and the first time is a time predicted by the core network function at which the first slice in a core network is not congested or at which the first slice becomes available in the core network.

19. The method as claimed in claim 15, further comprising at least one of the following:
receiving fifth information sent by the core network function, wherein the fifth information comprises a first time, and the first time is a time predicted by the core network function at which the first slice in a core network is not congested or at which the first slice becomes available in the core network;
sending sixth information to the core network function after the first time expires, wherein the sixth information is configured to inquire whether to establish or re-establish a PDU session associated with the first slice or inquire whether to modify a PDU session associated with a slice currently serving a UE; or
receiving fourth information sent by the core network function, wherein the fourth information is configured to request to establish or re-establish the PDU session associated with the first slice or request to modify the PDU session associated with the slice currently serving the UE, and the fourth information comprises first slice information configured to indicate the first slice.

20. A communication device, comprising a memory, a processor, and a computer program stored on the memory and executable on the processor, wherein the processor is configured to execute the computer program to perform a slice information transmission method, and the method comprises:
sending or receiving one or more pieces of first information;
wherein the one or more pieces of first information comprise second slice information, and one or more second slices indicated by the second slice information are configured to replace a first slice.
